(19) United States
(12) Patent Application Publication
(10) Pub. No.: US 2011/0029499 A1
(43) Pub. Date: Feb. 3, 2011

(54) CONTENT PROVIDING DEVICE, CONTENT PROVIDING METHOD, AND RECORDING MEDIUM

(75) Inventors: Masashi URUSHIHARA, Kawasaki (JP); Takashi Terasaki, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/846,709

(22) Filed: Jul. 29, 2010

(30) Foreign Application Priority Data
Aug. 3, 2009 (JP) 2009-180666

(51) Int. Cl. G06F 17/30

(52) U.S. Cl. 707/705; 707/E17.044

(57) ABSTRACT

A content providing device includes, a data storage unit configured to store data representing characteristics of content items, a retrieval unit configured to retrieve, on the basis of the data of a content item selected from the content items, the data of which is stored in the data storage unit, a content item different in type from the selected content item, and a display information output unit configured to output display information displaying the content item retrieved by the retrieval unit.

### CROSS-REFERENCE TO RELATED APPLICATIONS

This application is based upon and claims the benefit of priority of the prior Japanese Patent Application No. 2009-180666, filed on Aug. 3, 2009, the entire contents of which are incorporated herein by reference.

### BACKGROUND

A technique is known which acquires metadata of television programs, generates preference information of a user on the basis of the attributes of the metadata, retrieves recommendable metadata on the basis of the preference information, and presents the user with attributes constituting the preference information (Japanese Unexamined Patent Application Publication No. 2004-355340, for example).

### SUMMARY

According to an aspect of the invention, a content providing device includes: a data storage unit configured to store data representing characteristics of content items, a retrieval unit configured to retrieve, on the basis of the data of a content item selected from the content items, the data of which is stored in the data storage unit, a content item different in type from the selected content item, and a display information output unit configured to output display information displaying the content item retrieved by the retrieval unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first embodiment;

FIG. 2 is a diagram illustrating a hardware configuration of an information processing device of a second embodiment;

FIG. 3 is a block diagram illustrating a configuration of the information processing device of the second embodiment;

FIG. 4 is a diagram illustrating a configuration example of a news metadata table of the second embodiment;

FIG. 5 is a diagram illustrating a configuration example of a television program metadata table of the second embodiment;

FIG. 6 is a diagram illustrating a configuration example of a recorded program metadata table of the second embodiment;

FIG. 7 is a flowchart illustrating a procedure of recorded program metadata generation processing of the second embodiment;

FIG. 8 is a flowchart illustrating a procedure of image metadata generation processing of the second embodiment;

FIG. 9 is a flowchart illustrating a procedure of music metadata generation processing of the second embodiment;

FIG. 10 is a flowchart illustrating a procedure of news metadata generation processing of the second embodiment;

FIG. 11 is a flowchart illustrating a procedure of television program metadata generation processing of the second embodiment;

FIG. 12 is a flowchart illustrating a procedure of content retrieval processing of the second embodiment;

FIG. 13 is a diagram illustrating a content selection screen of the second embodiment;

FIG. 14 is a block diagram illustrating a configuration of an information processing device of a third embodiment;

FIG. 15 is a flowchart illustrating a procedure of content retrieval processing of the third embodiment;

FIG. 16 is a flowchart illustrating the procedure of content retrieval processing of the third embodiment;

FIG. 17 is a flowchart illustrating a procedure of preference metadata generation processing of the third embodiment; and

FIG. 18 is a diagram illustrating a content selection screen of the third embodiment.

### DESCRIPTION OF EMBODIMENTS

Embodiments will be described below with reference to the drawings.

### First Embodiment

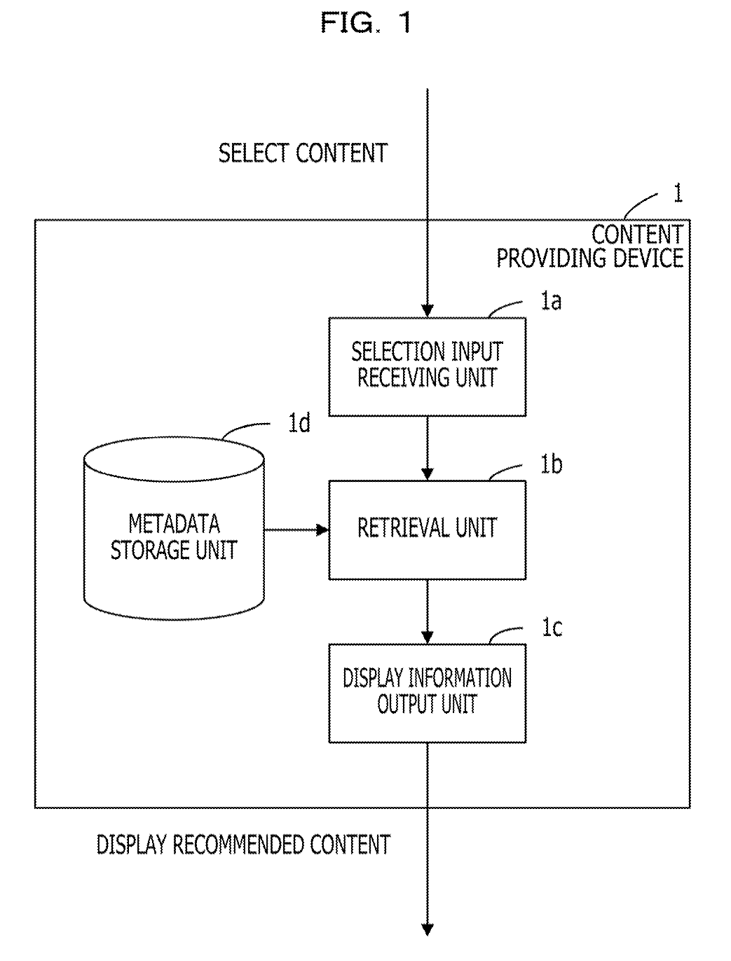

FIG. 1 is a diagram illustrating a first embodiment. A content providing device 1 illustrated in FIG. 1 presents a user with content items that are interesting to the user. The content providing device 1 includes a selection input receiving unit 1a, a retrieval unit 1b, a display information output unit 1c, and a metadata storage unit 1d.

The selection input receiving unit 1a receives an input of selection of a content item from a user. The content providing device 1 assumes that the content item selected by the user and received by the selection input receiving unit 1a is interesting to the user, and extracts a content item relevant to the selected content item as a content item interesting to the user.

On the basis of the metadata of the content item selected by the user and received by the selection input receiving unit 1a, which is stored in the metadata storage unit 1d, the retrieval unit 1b retrieves content items to be presented to the user. The retrieval unit 1b retrieves the content items from plural types of content items which may be provided to the user, by including other types of content items in the search scope. The types of content items include video, audio, multimedia content items, for example.

The display information output unit 1c outputs display information which displays the content items retrieved by the retrieval unit 1b. The display information may be presented to the user using a display or monitor (not illustrated), for example. With reference to the content items recommended by the presented display information, the user can view and/or listen to a content item.

The metadata storage unit 1d stores the metadata of each of the plural types of content items. Herein, the metadata refers to the data representing characteristics of a content item, e.g., the data generated from textual information relevant to the contents of each content item.

Accordingly, it is possible to present, from different types of content items, content items interesting to the user on the basis of the metadata of a content item selected by the content user.

### Second Embodiment

Subsequently, a second embodiment will be described.

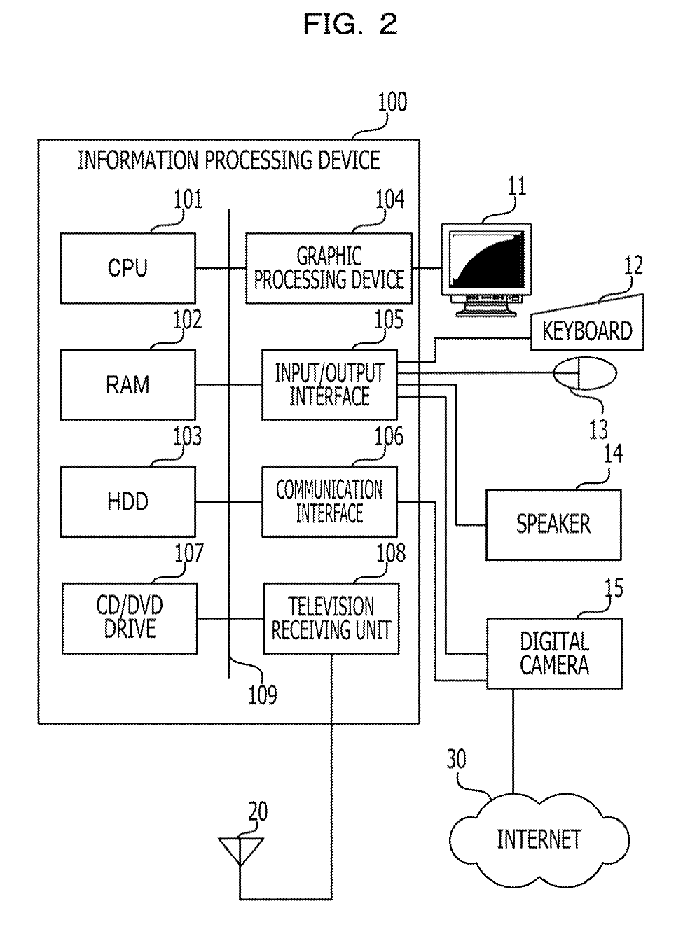

FIG. 2 is a diagram illustrating a hardware configuration of an information processing device of the second embodiment. The information processing device 100 illustrated in FIG. 2 is controlled by a CPU (Central Processing Unit) 101. The CPU 101 is connected, via a bus 109, to a RAM (Random Access Memory) 102, an HDD (Hard Disk Drive) 103, a graphic processing device 104, an input/output interface 105, a communication interface 106, a CD (Compact Disc)/DVD (Digital Versatile Disc) drive 107, and a television receiving unit 108.

The RAM 102 temporarily stores at least a part of programs of an OS (Operating System) executed by the CPU 101 and programs of application software (application programs). The RAM 102 further stores a variety of data used and/or necessary for the processing by the CPU 101. The HDD 103 stores the OS and application programs, for example.

The graphic processing device 104 is connected to a monitor 11. The graphic processing device 104 displays an image on the screen of the monitor 11 in accordance with a command from the CPU 101.

The input/output interface 105 is connected to a keyboard 12, a mouse 13, a speaker 14, and a digital camera 15. For example, the input/output interface 105 transmits a signal sent from the keyboard 12 or the mouse 13 to the CPU 101 via the bus 109, and outputs an audio signal based on the control of the CPU 101 to the speaker 14 via the bus 109. As another example, the input/output interface 105 transmits and receives, via the bus 109, the data of an image and additional information relating to the image exchanged between the digital camera 15 and the CPU 101.

The communication interface 106 can be connected to a communication line, such as, e.g., the Internet 30, a Local Area Network (LAN) (not illustrated), and cable television (not illustrated). Via the communication line, the communication interface 106 can transmit and receive data to and from an external device, such as another computer (illustration thereof is omitted) and a network drive (illustration thereof is omitted), for example. Further, news and program content data distributed through the communication line is acquired by the communication interface 106. Further, news and music data on the Web may be acquired by the communication interface 106 through the communication line.

The CD/DVD drive 107 is a device which accesses a magneto-optical disk, such as a CD and a DVD, for example, to read and write content data that provides a content item and additional information relating to the content item.

The television receiving unit 108, which includes, for example, a tuner, a demodulator, etc., captures the airwaves received by an antenna 20 connected thereto, to thereby acquire information representing television program content items of respective channels.

In the information processing device 100 of the present embodiment, the description has been made of a personal computer. However, the information processing device 100 is an example. Therefore, the present invention is applicable to various types of devices which enable viewing and/or listening of content items, such as a mobile communication terminal device including a mobile phone and a PDA (Personal Digital Assistant), a terminal device of an information processing system, and a content recording and reproducing device, for example.

The hardware configuration as described above is capable of realizing the processing function of the present embodiment.

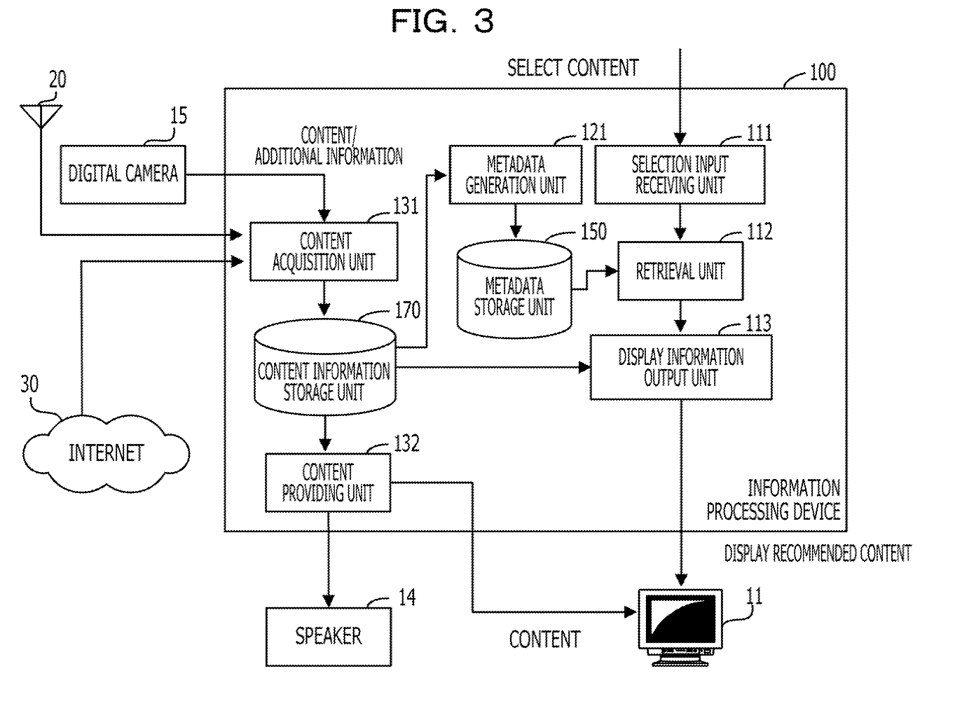

FIG. 3 is a block diagram illustrating a configuration of an information processing device of the second embodiment. The information processing device 100 illustrated in FIG. 3 includes a selection input receiving unit 111, a retrieval unit 112, a display information output unit 113, a metadata generation unit 121, a content acquisition unit 131, a content providing unit 132, a metadata storage unit 150, and a content information storage unit 170. Further, the display information output unit 113 is connected to the monitor 11. Further, the content acquisition unit 131 is connected to the digital camera 15, the antenna 20, and the Internet 30. Further, the content providing unit 132 is connected to the monitor 11 and the speaker 14.

The selection input receiving unit 111 receives an input of selection of a content item by a user. When inputting the selected content item, the user may use, as the selection input receiving unit 111, the keyboard 12 (described above in FIG. 2), the mouse 13 (described above in FIG. 2), a push button (illustration thereof is omitted), a touch panel (illustration thereof is omitted), or the like, for example.

Further, if the user further operates the selection input receiving unit 111 and thereby performs an operation for receiving the provision of the selected content item, the user may receive the provision of the content item by the content providing unit 132 and view and/or listen to the content item via the monitor 11 and/or the speaker 14, for example.

The retrieval unit 112 retrieves, on the basis of the metadata of the content item selected by the user and received by the selection input receiving unit 111 content items to be presented to the user from plural types of content items. The metadata of the content items are stored in the metadata storage unit 150. The plural types of content items may be provided to the user, by including other types of content items in the search scope, for example.

The display information output unit 113 outputs display information which displays the content items retrieved by the retrieval unit 112. The display information is presented to the user by the monitor 11 and so forth. The user may view and/or listen to a content item by referring to the content items recommended by the presented display information. With reference to the display of a list of content items displayed on the monitor 11 by the display information output unit 113, the user may selects a content item interesting to him or her.

Concerning the content item selected by the user and received by the selection input receiving unit 111, which is stored in the content information storage unit 170, the display information output unit 113 outputs display information including additional display information which displays details of the content item, such as additional information. Thereby, the details of the content item selected by the user are displayed.

The display information output unit 113 thus allows the user to, if the display of a list of content items displayed on the monitor 11 includes a content item interesting to the user, select the content item by operating the selection input receiving unit 111 to check the details of the content item. With the reception of the selection, the present embodiment is capable of identifying the content item in which the user is interested.

The display information output unit 113 displays a list of content items to the user, and outputs display information highlighting the content items retrieved by the retrieval unit 112. The present embodiment is thus capable of recommending to the user the content items determined to be interesting to the user, by highlighting the content items.

The metadata generation unit 121 acquires content data representing actual data of a content item and additional information relating to the content item, generates the metadata of the content item from the acquired content data and additional information, and stores the generated metadata in the metadata storage unit 150.

Herein, the generation of the metadata from the content data by the metadata generation unit 121 includes, for example, extracting a word from the text data of a text included in a news content item. Further, the generation of the metadata from the content data by the metadata generation unit may include, extracting a word on the basis of the text data extracted by character recognition from a telop (TELOP: TELevision Opaque Projector) text included in the video of a television program.

The metadata generation unit 121 analyzes the moving image of a content item such as, e.g., a television program and the (still) image of an image content item, to acquire by character extraction the text data from textual information such as a telop text included in the moving image and a caption included in the image. In the present embodiment, the thus obtained text data may be used as the metadata of the content item.

Further, the generation of the metadata from the additional information of a content item by the metadata generation unit 121 includes, for example, the extraction of a word from the text data of a title included in a news content item and the extraction of a word from the text data relating to a television program acquired from an EPG (Electronic Program Guide) of the television program.

The content acquisition unit 131 acquires the content data, which may be provided to the user and the additional information relating to the content item, and stores the acquired content data and additional information in the content information storage unit 170. The input/output interface 105, the communication interface 106, the CD/DVD drive 107, and the television receiving unit 108 described above in FIG. 2 operate as the content acquisition unit 131, for example.

In the present embodiment, any form of content may be used as content, including digital television broadcast, analog television broadcast, and Internet broadcast, for example, i.e., content which distributes video and audio, content which includes text and image data, such as a new site on the Internet, and content which includes video and audio data acquired by copying or downloading.

Further, in the present embodiment, content may be received through wireless communication via the antenna 20 or through wired communication via a communication line such as, e.g., the Internet 30, and may also be acquired from a recording medium.

Further, in the present embodiment, the broadcast of content may be received through wireless communication via the antenna 20 or through wired communication via a communication line such as, e.g., the Internet 30, as in Internet distribution. Further, in the present embodiment, content may be acquired by any acquisition method, such as, e.g., accessing a Web page to acquire content, acquiring content distributed by electronic mail, as in e-mail news distribution, and acquiring content from a recording medium such as a CD and a DVD, for example.

The content providing unit 132 provides the content item selected by the user and received by the selection input receiving unit 111. The content providing unit 132 outputs the data of the content item stored by the content information storage unit 170. Thereby, the user may view and/or listen to the content item stored in the content information storage unit 170.

The content providing unit 132 outputs, as signals, the contents of the content item to the monitor 11 and/or the speaker 14 connected to the information processing device 100, to thereby allow the user to view and/or listen to the content item via the device(s). However, the configuration is not limited thereto. Thus, the information processing device 100 may be configured to include a display unit (illustration thereof is omitted) and an audio output unit (illustration thereof is omitted) such that these units directly output the contents of the content item to be viewed and/or listened to by the user.

The metadata storage unit 150 stores the metadata of each of plural types of content items generated by the metadata generation unit 121. Herein, the metadata refers to, for example, the data generated from textual information relevant to the contents of each content item.

The content information storage unit 170 stores the content data and the additional information relating to the content item acquired by the content acquisition unit 131. The content information storage unit 170 may include a mass storage device, such as the HDD 103 described above in FIG. 2, for example, to store therein the content data and the additional information. Further, the content information storage unit 170 may store the content data and the additional information in any type of storage device, including an external storage device such as a network drive (illustration thereof is omitted) connected to the information processing device 100 and a removable disk such as the CD/DVD drive 107 described above in FIG. 2, for example.

The present embodiment “displays another content item relevant to the content item selected by the user” on the basis of the textual information obtained from the content data such as the telop text and the additional information such as the electronic program guide, for example. Accordingly, the present embodiment automatically retrieves and displays information relevant to the content item interesting to the user from a wide group of information pieces (e.g., content data on the Internet and local content data owned by the user), to thereby recommend the relevant information. Accordingly, the present embodiment allows the user to easily reach a content item interesting to him or her, and thus improves the convenience.

Further, it is considered that the preference of the user tends be common to different types of content items in many cases. The present embodiment is capable of presenting, from different types of content items, content items corresponding to the preference information.

Further, when the user selects a certain content item, other content items may be retrieved on the basis of the metadata of the selected content item. For example, when the user selects a content item, such as, e.g., the information data of a program scheduled to be broadcasted in the future, news information on the Internet, the analysis result or the Exif (Exchangeable Image File Format) data of photographic data, the genre information of music data, and lyrics information, the retrieval may be performed from the metadata extracted from videos with the use of the metadata of the selected content item, and a video extracted as a result of the retrieval may be recommended. It is thus possible, when the user selects a certain type of content item, to retrieve other types of content items matching the preference information, and to recommend the user different types of relevant content items.

Accordingly, it is possible to retrieve other content data in line with similarity and/or preference information from such video data and retrieve video data from other content data, and thus to further improve the convenience than ever before.

Subsequently, tables used in the present embodiment will be described.

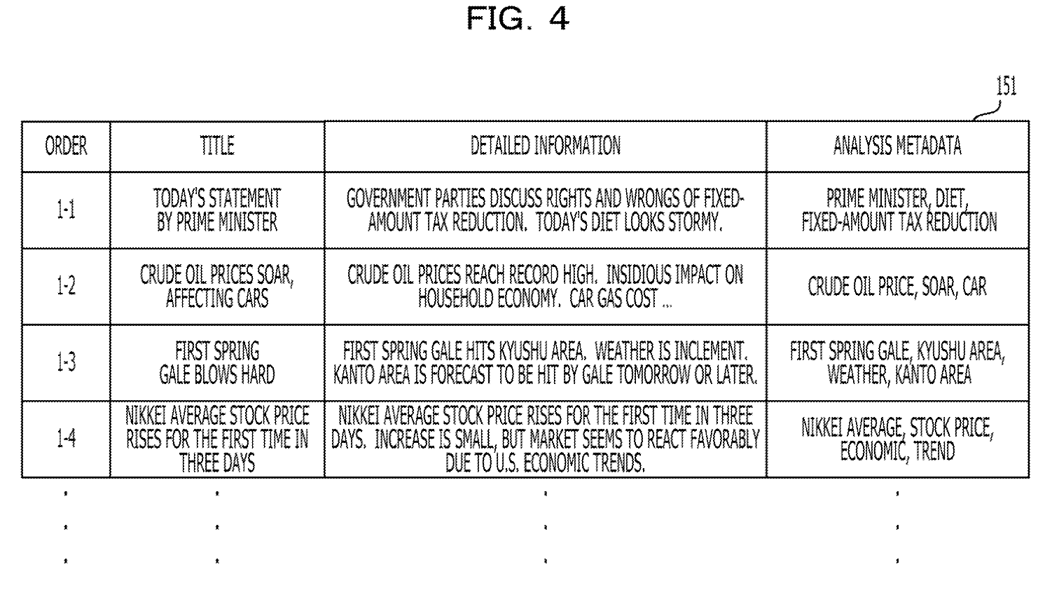

FIG. 4 is a diagram illustrating a configuration example of a news metadata table of the second embodiment. A news metadata table 151 illustrated in FIG. 4 is stored in the metadata storage unit 150 (described above in FIG. 3), and is created and managed by the information processing device 100. The news metadata table 151 is a table for storing news metadata which is the metadata for retrieving news content items in the content providing function of the information processing device 100.

The news metadata table 151 includes example categories of “ORDER,” “TITLE,” “DETAILED INFORMATION,” and “ANALYSIS METADATA.” In the news metadata table 151, information pieces arranged in the horizontal direction in each of items are associated with one another as the news metadata.

The information processing device 100 of the present embodiment may automatically acquire, via the Internet 30 (described above in FIG. 2), a news item acquired from a Web site which distributes news, and provides the text of the news item on the basis of the selection by the user.

The order refers to the code allocated to each of news metadata items to uniquely identify the news metadata item.

The title refers to the text data representing the title of the news item. Herein, the headline of the news item, for example, may be used as the title.

The detailed information refers to the text data representing the contents of the news item. Herein, the text data of a news text may be used.

The analysis metadata refers to the metadata generated by extraction of a word from the text data, such as the title and the detailed information, for example. The present embodiment retrieves respective news items on the basis of the metadata.

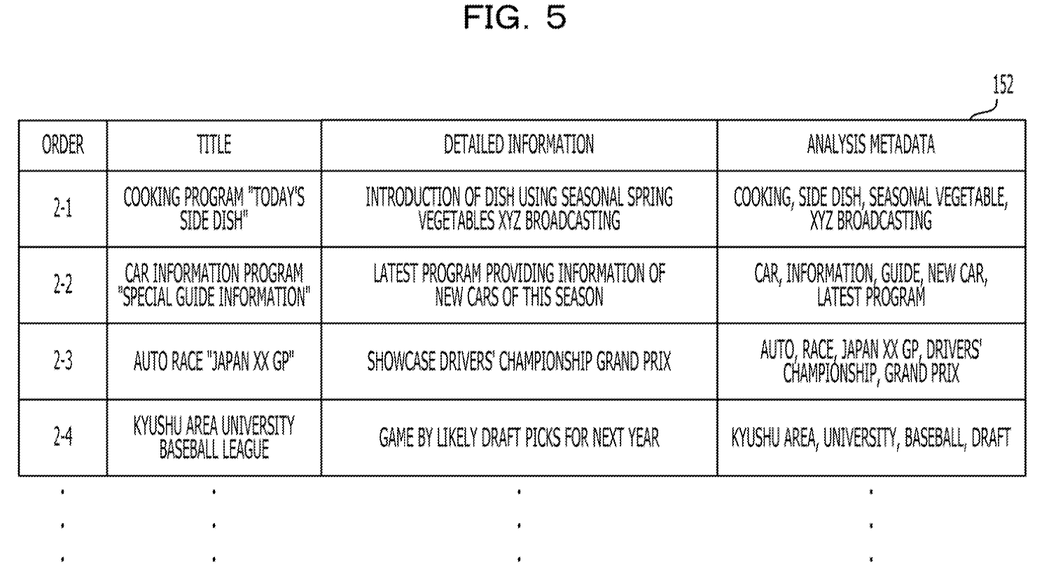

FIG. 5 is a diagram illustrating a configuration example of a television program metadata table of the second embodiment. A television program metadata table 152 illustrated in FIG. 5 is stored in the metadata storage unit 150 (described above in FIG. 3), and is created and managed by the information processing device 100. The television program metadata table 152 is a table for storing television program metadata which is the metadata for retrieving television program content items in the content providing function of the information processing device 100.

The television program metadata table 152 includes example categories of “ORDER,” “TITLE,” “DETAILED INFORMATION,” and “ANALYSIS METADATA.” In the television program metadata table 152, information pieces arranged in the horizontal direction in each of items are associated with one another as the television program metadata.

The television program metadata is generated from the additional information of a television program, such as the electronic program guide acquired from the antenna 20 and so forth.

The information processing device 100 of the present embodiment receives, via the antenna 20 (described above in FIG. 2), the radio waves transmitted from a broadcasting station (illustration thereof is omitted) which broadcasts television programs, automatically acquires the television programs, and acquires the electronic program guide. Further, on the basis of the selection of a content item by the user, the information processing device 100 extracts from the electronic program guide the television programs which are scheduled to be broadcasted and are relevant to the content item, to thereby recommend the extracted television programs to the user.

The order refers to the code allocated to each of television program metadata items to uniquely identify the television program metadata item.

The title refers to the text data representing the title of the television program. Herein, the title of the television program, for example, may be used as the title.

The detailed information refers to the text data representing the contents of the television program and so forth. Herein, the text data extracted by character recognition from a telop text included in the television program, the text data of a text broadcast, and so forth may be used.

The analysis metadata refers to the metadata generated by extraction of a word from the text data, such as the title and the detailed information, for example. The present embodiment retrieves respective television programs on the basis of the metadata.

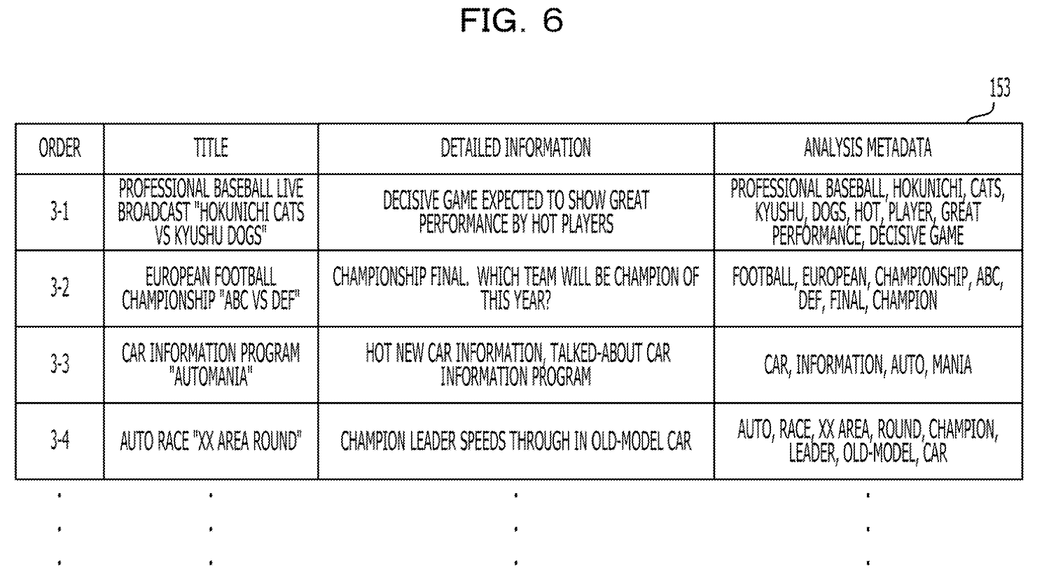

FIG. 6 is a diagram illustrating a configuration example of a recorded program metadata table of the second embodiment. A recorded program metadata table 153 illustrated in FIG. 6 is stored in the metadata storage unit 150 (described above in FIG. 3), and is created and managed by the information processing device 100. The recorded program metadata table 153 is a table for storing recorded program metadata which is the metadata for retrieving recorded program content items in the content providing function of the information processing device 100.

The recorded program metadata table 153 includes example categories of “ORDER,” “TITLE,” “DETAILED INFORMATION,” and “ANALYSIS METADATA.” In the recorded program metadata table 153, information pieces arranged in the horizontal direction in each of items are associated with one another as the recorded program metadata.

The recorded program metadata may be generated from the textual information included in the video represented by the content data of a recorded program and the additional information, such as, e.g., the electronic program guide, of the television program being the source of the recorded program.

The information processing device 100 of the present embodiment provides a recorded program by reproducing, on the basis of the selection by the user, the recorded program recorded with the reception, via the antenna 20 (described above in FIG. 2), of the radio waves transmitted from a broadcasting station (illustration thereof is omitted) which broadcasts the recorded program.

The order refers to the code allocated to each of recorded program metadata items to uniquely identify the recorded program metadata item.

The title refers to the text data representing the title of the recorded program. Herein, the title of the recorded program, for example, may be used as the title.

The detailed information refers to the text data representing the contents of the recorded program and so forth. Herein, the text data extracted by character recognition from a telop text included in the recorded program, the text data of a text broadcast, the text data of the television program being the source of the recorded program and included in the electronic program guide acquired from the antenna 20, and so forth may be used.

The analysis metadata refers to the metadata generated by extraction of a word from the text data, such as, e.g., the title and the detailed information. The present embodiment retrieves respective recorded programs on the basis of the metadata.

FIGS. 4 to 6 illustrate examples of the metadata of news, television programs to be broadcasted, and recorded programs recorded from broadcasted television programs. The metadata is not limited thereto. Thus, the information processing device 100 can generate the metadata of content items available to the user, such as music content items and image content items, for example.

The content providing function of the information processing device 100 generates the metadata by analyzing the additional information of the content items available to the user, and stores the metadata in the metadata storage unit 150. On the basis of the metadata, the content items to be recommended to the user are retrieved.

Subsequently, the processing performed by the present embodiment will be described.

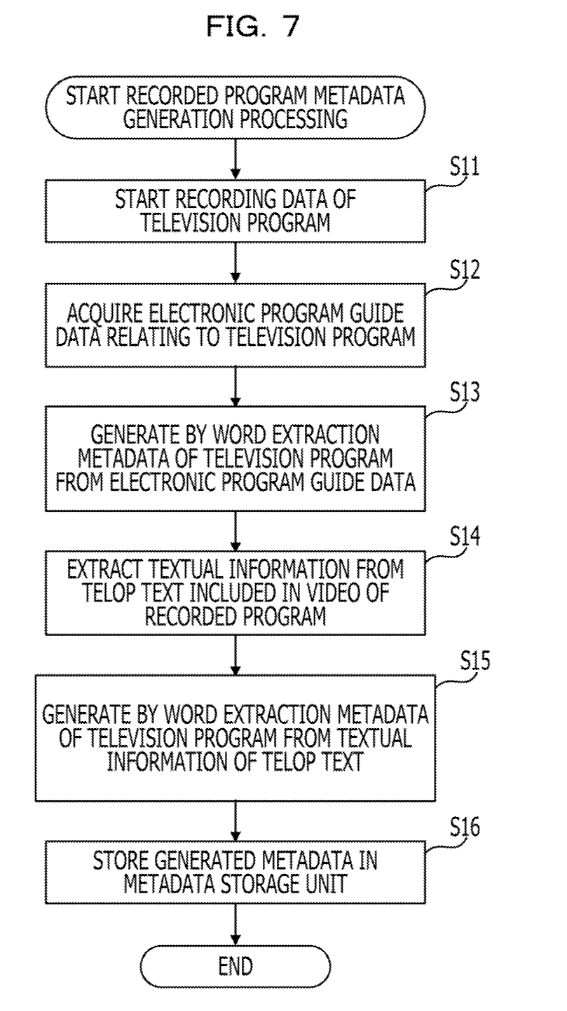

FIG. 7 is a flowchart illustrating a procedure of recorded program metadata generation processing of the second embodiment. In the recorded program metadata generation processing illustrated in FIG. 7, the information processing device 100 (described above in FIG. 2) generates the metadata from the electronic program guide data of a television program or a telop text included in the program, for example. The recorded program metadata generation processing starts to be performed when, for example, the recording (video recording) of a television program is performed.

[S11] The content acquisition unit 131 (described above in FIG. 3) starts recording the data of a television program, which is a content item to be recorded. Thereby, the reproduction data of the television program is stored in the content information storage unit 170 (described above in FIG. 3).

[S12] The content acquisition unit 131 acquires the electronic program guide data of the television program being recorded at S11, and stores the electronic program guide data in the content information storage unit 170.

[S13] The metadata generation unit 121 (described above in FIG. 3) reads from the content information storage unit 170 the electronic program guide data stored at S12, and generates by word extraction the metadata of the television program being recorded.

[S14] The metadata generation unit 121 reads from the content information storage unit 170 the data of the television program being recorded at S11 as the data of a recorded program, and extracts the textual information of a telop text included in the video of the recorded program.

[S15] From the textual information extracted from the telop text at S14, the metadata generation unit 121 generates by word extraction the metadata of the television program being recorded.

[S16] The metadata generation unit 121 stores in the metadata storage unit 150 (described above in FIG. 3) the metadata of the television program generated at S13 and S15. Thereafter, the processing is completed.

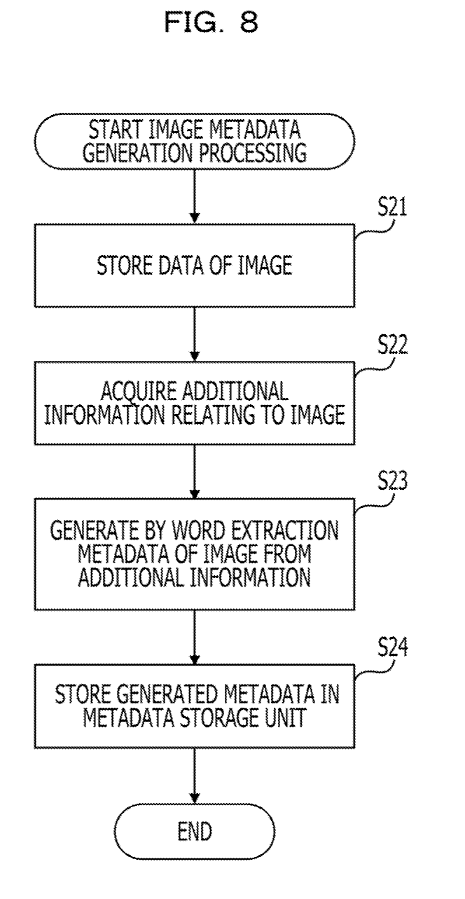

FIG. 8 is a flowchart illustrating a procedure of image metadata generation processing of the second embodiment. In the image metadata generation processing illustrated in FIG. 8, the information processing device 100 (described above in FIG. 2) generates the metadata of an image. The image metadata generation processing starts to be performed when, for example, the data of an image is acquired from the digital camera 15 (described above in FIG. 2) or the like.

[S21] The content acquisition unit 131 (described above in FIG. 3) acquires the data of an image, and stores the data in the content information storage unit 170 (described above in FIG. 3).

[S22] The content acquisition unit 131 acquires the additional information of the image stored at S21, and stores the additional information in the content information storage unit 170. For example, the additional information of an image be a source of the image, photographer, general characteristic (e.g., landscape, automotive, portrait), format, etc.

[S23] The metadata generation unit 121 (described above in FIG. 3) reads from the content information storage unit 170 the additional information stored at S22, and generates by word extraction the metadata of the image.

[S24] The metadata generation unit 121 stores in the metadata storage unit 150 (described above in FIG. 3) the metadata of the image generated at S23. Thereafter, the processing is completed.

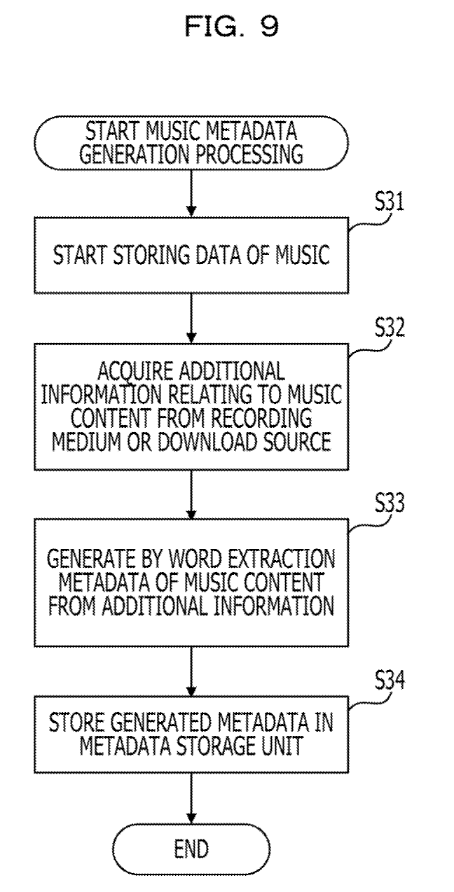

FIG. 9 is a flowchart illustrating a procedure of music metadata generation processing of the second embodiment. In the music metadata generation processing illustrated in FIG. 9, the information processing device 100 (described above in FIG. 2) generates the metadata of a music piece. The music metadata generation processing starts to be performed when, for example, the data of a music piece is acquired from a Web site connected via the Internet 30, the CD/DVD drive 107 (described above in FIG. 2), or the like.

[S31] The content acquisition unit 131 (described above in FIG. 3) acquires the data of a music piece, and stores the data in the content information storage unit 170 (described above in FIG. 3).

[S32] The content acquisition unit 131 acquires the additional information of the music piece stored at Step S31, and stores the additional information in the content information storage unit 170. The additional information of the music piece is textual information relevant to the music piece, and corresponds to, for example, authorship information such as, e.g., the lyricist, the composer, and the performer who sings the music piece, the lyrics, and the title of the song or album.

[S33] The metadata generation unit 121 (described above in FIG. 3) reads from the content information storage unit 170 the additional information stored at S32, and generates by word extraction the metadata of the music piece.

[S34] The metadata generation unit 121 stores in the metadata storage unit 150 (described above in FIG. 3) the metadata of the music piece generated at S33. Thereafter, the processing is completed.

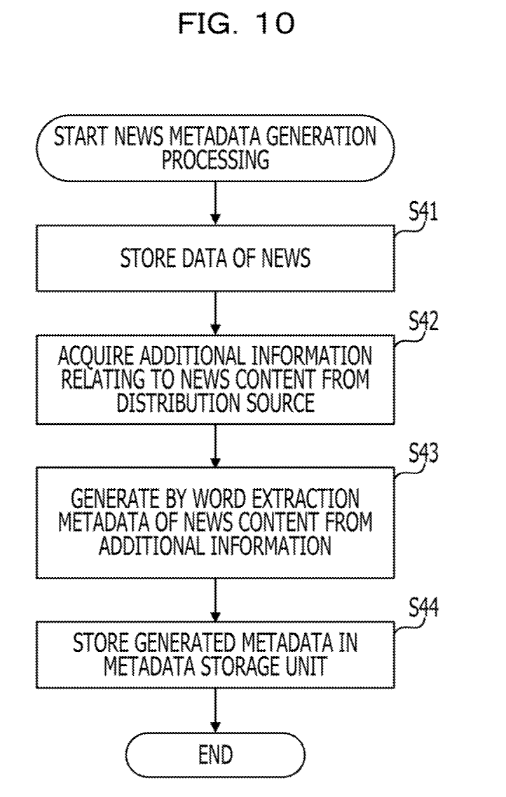

FIG. 10 is a flowchart illustrating a procedure of news metadata generation processing of the second embodiment. In the news metadata generation processing illustrated in FIG. 10, the information processing device 100 (described above in FIG. 2) generates the metadata of a news item. The news metadata generation processing starts to be performed when, for example, the data of a news item is acquired from a Web site connected via the Internet 30 or the like.

[S41] The content acquisition unit 131 (described above in FIG. 3) acquires the data of a news item, and stores the data in the content information storage unit 170 (described above in FIG. 3).

[S42] The content acquisition unit 131 acquires the additional information of the news item stored at S41, and stores the additional information in the content information storage unit 170. The additional information of the news item is textual information relevant to the news item, and corresponds to, for example, the title of the news item, the text, and a caption included in the image of the news item.

[S43] The metadata generation unit 121 (described above in FIG. 3) reads from the content information storage unit 170 the additional information stored at S42, and generates by word extraction the metadata of the news item. The additional information may be the source of the new item, new organization responsible for the new item, general new category (e.g., politics, current events, local news), etc.

[S44] The metadata generation unit 121 stores in the metadata storage unit 150 (described above in FIG. 3) the metadata of the news item generated at S43. Thereafter, the processing is completed.

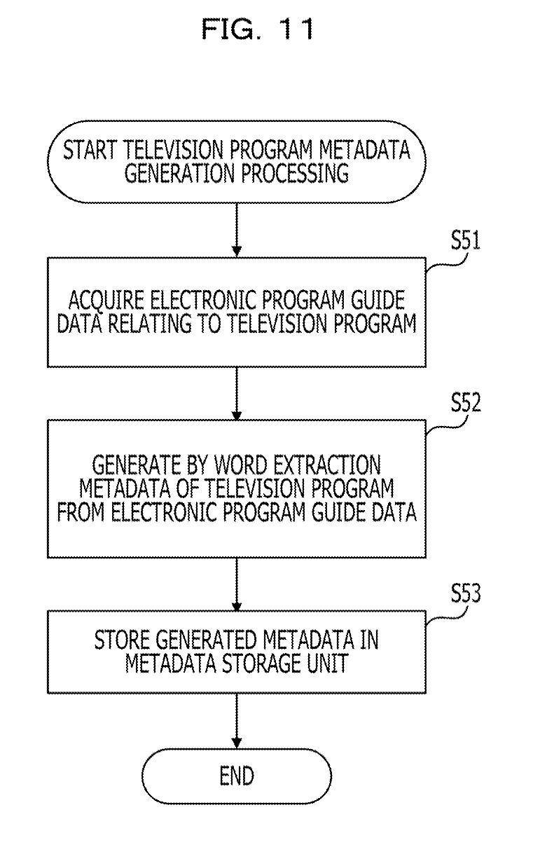

FIG. 11 is a flowchart illustrating a procedure of television program metadata generation processing of the second embodiment. In the television program metadata generation processing illustrated in FIG. 11, the information processing device 100 (described above in FIG. 2) generates the metadata from the electronic program guide data of a television program. The television program metadata generation processing starts to be performed when, for example, the electronic program guide data is acquired.

[S51] The content acquisition unit 131 (described above in FIG. 3) stores the acquired electronic program guide data of the television program in the content information storages unit 170.

[S52] The metadata generation unit 121 (described above in FIG. 3) reads from the content information storage unit 170 the electronic program guide data stored at S51, and generates by word extraction the metadata of the television program.

[S53] The metadata generation unit 121 stores in the metadata storage unit 150 (described above in FIG. 3) the metadata of the television program generated at S52. Thereafter, the processing is completed.

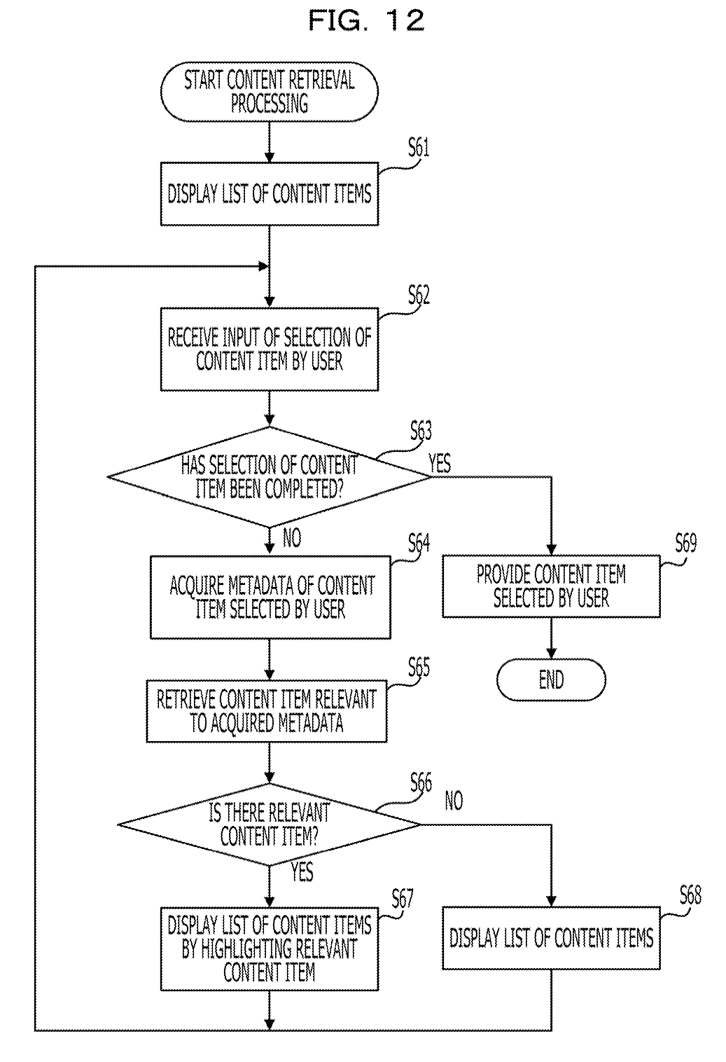

FIG. 12 is a flowchart illustrating a procedure of content retrieval processing of the second embodiment. In the content retrieval processing illustrated in FIG. 12, the information processing device 100 (described above in FIG. 2) displays a content item to be recommended to the user, on the basis of the selection by the user and the metadata. The content retrieval processing starts to be performed when an operation by the user for viewing and/or listening to a content item is received.

[S61] With the information processing device 100 outputting the display information displaying a list of content items available to the user, the display information output unit 113 (described above in FIG. 3) displays the content items on the monitor 11 (described above in FIG. 3).

[S62] The selection input receiving unit 111 (described above in FIG. 3) receives an input of selection by the user of a content item to be viewed and/or listened to from the content items displayed at S61. Further, in this operation, information representing details of the contents of the content item, such as, e.g., the additional information of the content item selected by the user, is displayed on the monitor 11.

[S63] The selection input receiving unit 111 determines whether or not the user has completed the input of selection of a content item and an input for viewing and/or listening to the content item selected at S62 has been received. If the input of selection of a content item has been completed and the input for viewing and/or listening to the content item has been received, the processing proceeds to S69. Meanwhile, if an input for continuing the input of selection of a content item has been received, the processing proceeds to S64. Stated differently, receiving an input of a selection of content item by a user is not the same a completing the selection of a content item. For example, in response to receiving an input of the selection of a content item by a user, the system may provide other items the user may wish to select prior to the selection of one or more content items being completed. As another example, a selection may not be considered completed until an instruction indicating the user does not wish to select any additional content has not been received. The instruction indicates that the user wishes to discontinue the selection process.

[S64] The retrieval unit 112 (described above in FIG. 3) acquires from the metadata storage unit 150 (described above in FIG. 3) the metadata of the content item corresponding to the selection which has been received at S62.

[S65] The retrieval unit 112 retrieves a content item relevant to the metadata acquired at S64. Herein, on the basis of a word included in the acquired metadata, the retrieval unit 112 performs the retrieval on the metadata stored in the metadata storage unit 150. For example, if the above-described word appears a specified and/or predetermined number of times or more in the metadata of a content item, the retrieval unit 112 extracts the content item. Thereby, a relevant content item may be extracted.

[S66] The retrieval unit 112 determines, on the basis of the result of the retrieval at S65, whether or not there is a content item relevant to the selected content item. If there is a relevant content item, the processing proceeds to S67. Meanwhile, if there is no relevant content item, the processing proceeds to S68.

[S67] With the information processing device 100 outputting the display information displaying a list of content items available to the user, the display information output unit 113 displays the content items on the monitor 11 such that the relevant content item is highlighted. Thereafter, the processing proceeds to S62.

[S68] With the information processing device 100 outputting the display information displaying a list of content items available to the user, the display information output unit 113 displays the content items on the monitor 11. Thereafter, the processing proceeds to S62.

[S69] The content providing unit 132 (described above in FIG. 3) provides the content item, for which the input by the user for viewing and/or listening has been received, by reading the content item from the content information storage unit 170 (described above in FIG. 3). Thereafter, the processing is completed.

Subsequently, description will be made of a display screen displayed in the present embodiment.

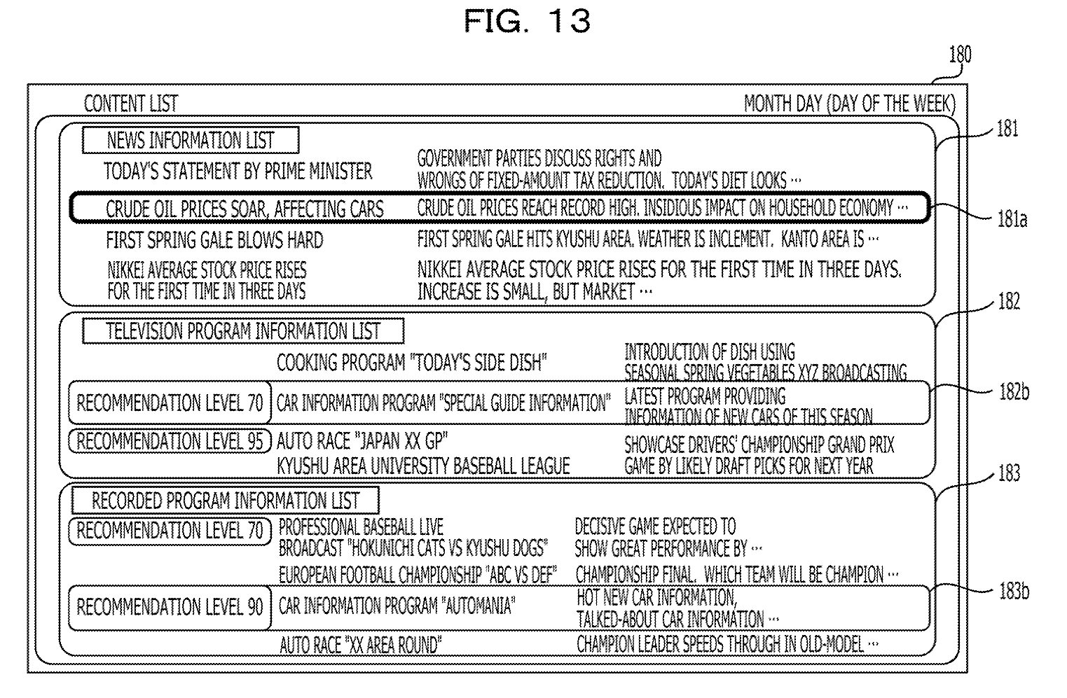

FIG. 13 is a diagram illustrating a content selection screen of the second embodiment. A content selection screen 180 illustrated in FIG. 13 is a screen displayed on the monitor 11 (described above in FIG. 2) of the information processing device 100 (described above in FIG. 2). The content selection screen 180 is an example of a content selection screen for displaying a list of content items available to the user and receiving an input of selection of a content item.

The content selection screen 180 includes content display areas 181, 182, and 183. Further, the content display area 181 includes a selected content display area 181a displaying a content item selected by the user. The content display areas 182 and 183 respectively include relevant content highlight areas 182b and 183b, each of which highlights a content item relevant to the content item selected by the user such that the relevant content item is distinguishable from other content items.

Each of the content display areas 181, 182, and 183 is an area for displaying, by type of content, a list of content items available to the user in the content providing function of the information processing device 100. The content display area 181 is an area for displaying a list of news content items. The content display area 182 is an area for displaying a list of television program content items. The content display area 183 is an area for displaying a list of recorded program content items.

The user may change the content item to be selected, by shifting the selected content display area 181a with the operation of, for example, the mouse 13 (described above in FIG. 2) connected to the information processing device 100. Further, with an operation such as the clicking of the mouse 13 performed in the selected state of a content item, the user can display a not-illustrated content detail screen to display information representing the details of the content item. Furthermore, with further operation such as the clicking of the mouse 13, the user can display (reproduce) the selected content item to view and/or listen to the content item.

If the user shifts the selected content display area 181a and selects one of the content items displayed in a list on the content selection screen 180 (e.g., “CRUDE OIL PRICES SOAR, AFFECTING CARS” in NEWS INFORMATION LIST), content items extracted as a result of retrieval performed on the basis of the metadata of the selected content item (e.g., “CAR INFORMATION PROGRAM ‘SPECIAL GUIDE INFORMATION’” in TELEVISION PROGRAM INFORMATION LIST and “CAR INFORMATION PROGRAM ‘AUTOMANIA’” in RECORDED PROGRAM INFORMATION LIST) are highlighted in, for example, bold and italic type, as in the relevant content highlight areas 182b and 183b. The highlighting may be performed with the use of any display method which displays a content item to be distinguishable from the display of other content items, such as, e.g., changing the color or brightness of the letters representing the content item or the area surrounding the letters and blinking the letters or the area surrounding the letters.

In addition to the presentation of the content item relevant to the metadata, it is also possible to recommend the user a content item from a broader point of view by performing “recommendation display” of, for example, a content item viewed and/or listened to by a large number of users or a content item recommended by the provider thereof.

As described above, the second embodiment displays, on the content selection screen 180, a list of content items available to the user. Further, if the user selects a content item interesting to him from the display of the list, other types of content items relevant to the selected content item are highlighted on the basis of the metadata of the selected content item. Accordingly, it is possible to present and recommend, from different types of content items, content items interesting to the user.

### Third Embodiment

Subsequently, a third embodiment will be described. The description will be mainly made of differences from the above-described second embodiment. Similar items will be denoted by the same reference numerals, and description thereof will be omitted.

The third embodiment is different from the second embodiment in that the embodiment generates preference metadata of the content item selected by the user, and that the embodiment allows the user to select the content item to be viewed and/or listened to from the display of a list of content items based on the preference metadata.

Preference metadata refers to metadata representing preferences of a user. For example, the preference metadata may be obtained by retaining metadata of a users previous selected content items and identifying patterns within the retained metadata. Alternatively, the preference metadata may be obtained or generated based on a user's response to a questionnaire completed prior to selection of a content item.

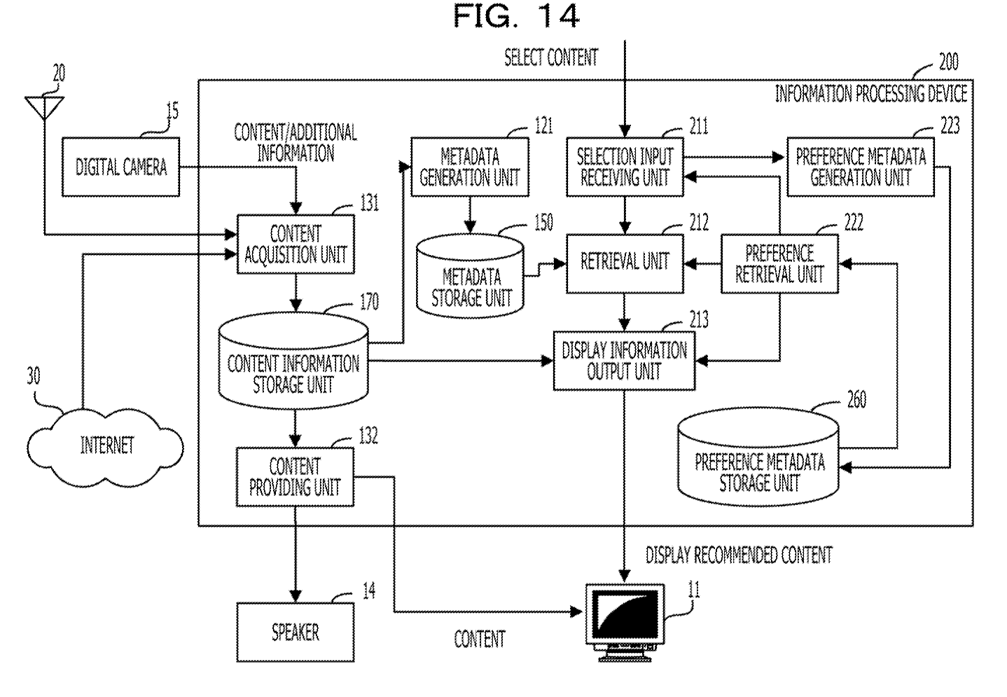

FIG. 14 is a block diagram illustrating a configuration of an information processing device of the third embodiment. An information processing device 200 illustrated in FIG. 14 includes the metadata generation unit 121, the content acquisition unit 131, the content providing unit 132, the metadata storage unit 150, the content information storage unit 170, a selection input receiving unit 211, a retrieval unit 212, a display information output unit 213, a preference retrieval unit 222, a preference metadata generation unit 223, and a preference metadata storage unit 260. Further, similar to the display information output unit 113 of the second embodiment, the display information output unit 213 is connected to the monitor 11. Further, similarly as in the second embodiment, the content acquisition unit 131 is connected to the digital camera 15, the antenna 20, and the Internet 30. Further, similarly as in the second embodiment, the content providing unit 132 is connected to the monitor 11 and the speaker 14.

Similar to the selection input receiving unit 111 of the second embodiment, the selection input receiving unit 211 receives an input of selection of a content item by the user. Further, with further operation of the selection input receiving unit 211 to perform an operation for receiving the provision of the selected content item, the user may receive the provision of the content item by the content providing unit 132 and view and/or listen to the content item via the monitor 11 and/or the speaker 14.

Similar to the retrieval unit 112 of the second embodiment, the retrieval unit 212 retrieves, on the basis of the metadata of the content item selected by the user and received by the selection input receiving unit 211, which is stored in the metadata storage unit 150, content items to be presented to the user from plural types of content items available to the user, by including other types of content items in the search scope.

Similar to the display information output unit 113 of the second embodiment, the display information output unit 213 outputs display information which displays the content items retrieved by the retrieval unit 212. The display information is presented to the user by the monitor 11 and so forth. Further, concerning the content item selected by the user and received by the selection input receiving unit 211, which is stored in the content information storage unit 170, the display information output unit 213 outputs display information including additional display information which displays details of the content item, such as additional information, for example.

Similarly as in the second embodiment, the metadata generation unit 121 acquires the content data and the additional information relating to the content item, generates the metadata of the content item from the acquired content data and additional information, and stores the generated metadata in the metadata storage unit 150.

Similarly as in the second embodiment, the content acquisition unit 131 acquires the content data available to the user and the additional information relating to the content item, and stores the acquired content data and additional information in the content information storage unit 170.

Similarly as in the second embodiment, the content providing unit 132 provides the content item selected by the user and received by the selection input receiving unit 211. The content providing unit 132 outputs the data of the content item stored by the content information storage unit 170.

Similarly as in the second embodiment, the metadata storage unit 150 stores the metadata of each of plural types of content items generated by the metadata generation unit 121.

Similarly as in the second embodiment, the content information storage unit 170 stores the content data and the additional information relating to the content item acquired by the content acquisition unit 131.

The selection input receiving unit 211 receives an input of selection of a content item by the user from the content items retrieved by the preference retrieval unit 222.

On the basis of the metadata of the content item selected by the user and received by the selection input receiving unit 211, which is stored in the metadata storage unit 150, the retrieval unit 212 retrieves the content items to be presented to the user from the content items retrieved by the preference retrieval unit 222, by including other types of content items in the search scope, for example.

The display information output unit 213 outputs preference display information which displays a list of content items retrieved by the preference retrieval unit 222.

On the basis of the preference metadata stored in the preference metadata storage unit 260, the preference retrieval unit 222 retrieves the content items to be presented to the user from plural types of content items available to the user, by including other types of content items in the search scope, for example.

The preference metadata generation unit 223 acquires the content data and the additional information relating to the content item selected by the user and received by the selection input receiving unit 211, which is stored in the content information storage unit 170, generates the preference metadata from the acquired content data and additional information, and stores the generated preference metadata in the preference metadata storage unit 260.

The preference metadata storage unit 260 stores the preference metadata of plural types of content items representing the preference of the user and generated by the preference metadata generation unit 223. Herein, similarly to the metadata, the preference metadata refers to, for example, the data generated from textual information relevant to the contents of each content item.

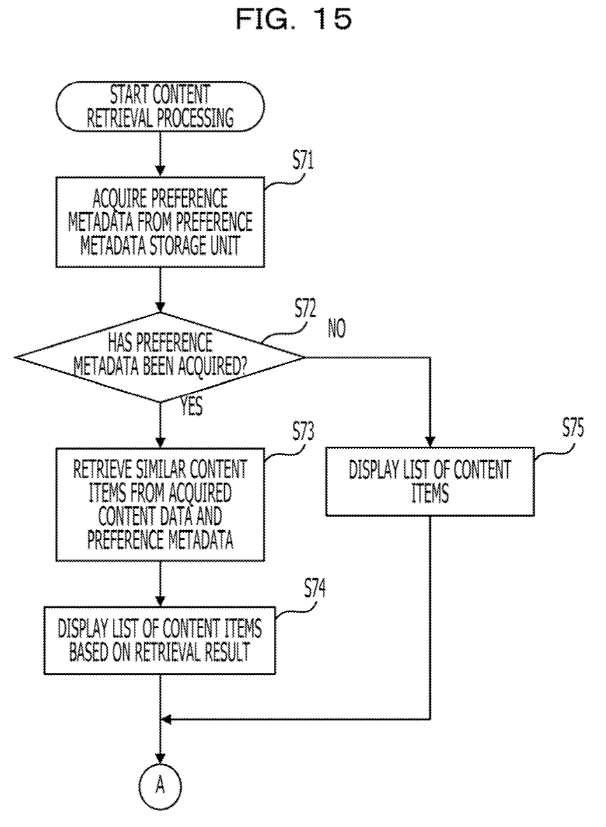

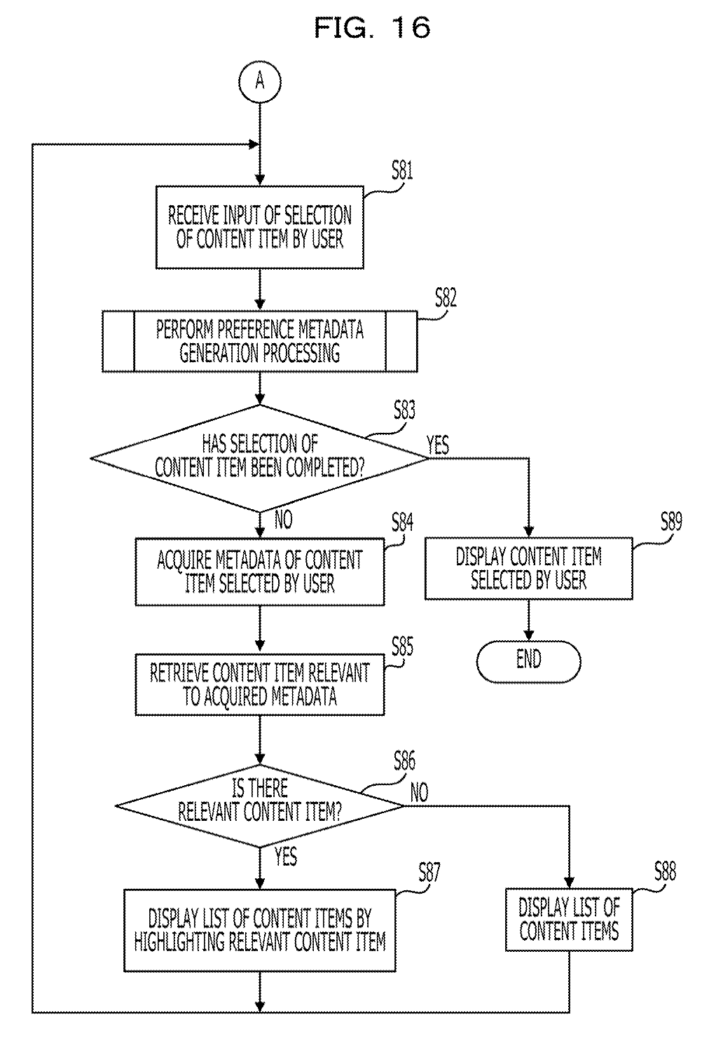

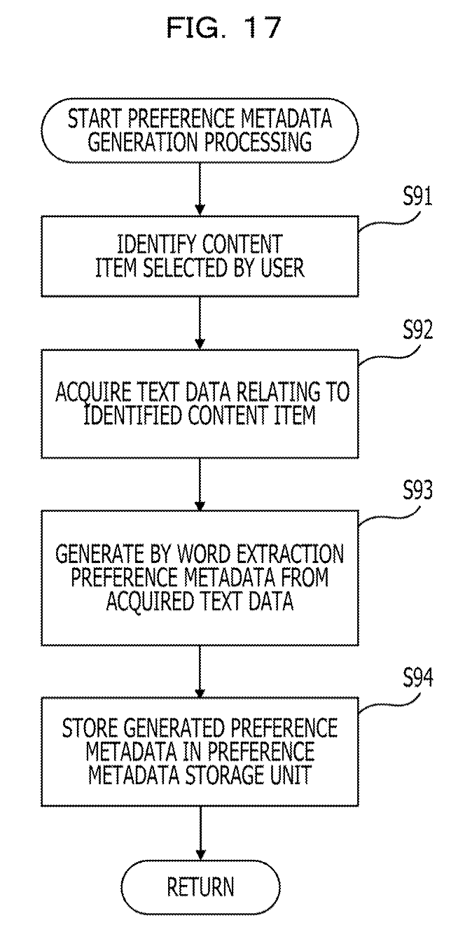

FIGS. 15 and 16 are flowcharts illustrating a procedure of content retrieval processing of the third embodiment. In the content retrieval processing illustrated in FIGS. 15 and 16, the information processing device 200 (described above in FIG. 14) displays a content item to be recommended to the user, on the basis of the content item selected by the user from the content items displayed in a list on the basis of the preference metadata and the metadata of the content item. The content retrieval processing starts to be performed when an operation by the user for viewing and/or listening to a content item is received.

[S71] The preference retrieval unit 222 (described above in FIG. 14) acquires the preference metadata from the preference metadata storage unit 260 (described above in FIG. 14).

[S72] The preference retrieval unit 222 determines whether or not the preference metadata has been successfully acquired at S71. If the preference metadata has been successfully acquired, the processing proceeds to S73. Meanwhile, if the preference metadata has not been successfully acquired, the processing proceeds to S75.

[S73] The preference retrieval unit 222 retrieves from the preference metadata the metadata of the content items available to the user, and extracts content items which have similarity to the preference metadata.

[S74] With the information processing device 200 outputting to the user display information displaying a list of content items extracted at S73, the display information output unit 213 (described above in FIG. 14) displays the content items on the monitor 11 (described above in FIG. 14). Thereafter, the processing proceeds to S81 (FIG. 16).

[S75] With the information processing device 200 outputting display information displaying a list of content items available to the user, the display information output unit 213 displays the content items on the monitor 11. Thereafter, the processing proceeds to S81.

[S81] The selection input receiving unit 211 (described above in FIG. 14) receives an input of selection by the user of a content item to be viewed and/or listened to from the content items displayed at S74 or S75. Further, in this operation, information representing details of the contents of the content item, such as, e.g, the additional information of the content item selected by the user, is displayed on the monitor 11.

[S82] The preference metadata generation unit 223 (described above in FIG. 14) performs preference metadata generation processing (described later in FIG. 17).

[S83] The selection input receiving unit 211 determines whether or not the user has completed the input of selection of a content item and the input for viewing and/or listening to the content item selected at S81 has been received. If the input of selection of a content item has been completed and the input for viewing and/or listening to the content item has been received, the processing proceeds to S89. Meanwhile, if an input for continuing the input of selection of a content item has been received, the processing proceeds to S84.

[S84] The retrieval unit 212 (described above in FIG. 14) acquires from the metadata storage unit 150 (described above in FIG. 14) the metadata of the content item, the selection of which has been received at S81.

[S85] The retrieval unit 212 retrieves a content item relevant to the metadata acquired at S84. Herein, the retrieval unit 212 performs, on the basis of a word included in the acquired metadata, the retrieval on the metadata stored in the metadata storage unit 150. For example, if the above-described word appears a specified and/or predetermined number of times or more in the metadata of a content item, the retrieval unit 212 extracts the content item. Thereby, a relevant content item is extracted.

[S86] The retrieval unit 212 determines, on the basis of the result of the retrieval at S85, whether or not there is a content item relevant to the selected content item. If there is a relevant content item, the processing proceeds to S87. Meanwhile, if there is no relevant content item, the processing proceeds to S88.

[S87] With the information processing device 200 outputting the display information displaying a list of content items available to the user, the display information output unit 213 displays the content items on the monitor 11 such that the relevant content item is highlighted. Thereafter, the processing proceeds to S81.

[S88] With the information processing device 200 outputting the display information displaying a list of content items available to the user, the display information output unit 213 displays the content items on the monitor 11. Thereafter, the processing proceeds to S81.

[S89] The content providing unit 132 (described above in FIG. 14) provides the content item, for which the input by the user for viewing and/or listening has been received, by reading the content item from the content information storage unit 170 (described above in FIG. 14). Thereafter, the processing is completed.

FIG. 17 is a flowchart illustrating a procedure of preference metadata generation processing of the third embodiment. In the preference metadata generation processing illustrated in FIG. 17, the information processing device 200 (described above in FIG. 14) generates the preference metadata. The preference metadata generation processing starts to be performed when invoked in the content retrieval processing described above in FIGS. 15 and 16.

[S91] The preference metadata generation unit 223 (described above in FIG. 14) identifies the content item selected by the user in the content retrieval processing described above in FIGS. 15 and 16.

[S92] The preference metadata generation unit 223 acquires text data relating to the content item identified at S91. In this operation, the preference metadata generation unit 223 is capable of arbitrarily acquiring the text data relating to the content item from both or one of the content data and the additional information of the content item.

Specifically, if the content item is program content, for example, it is possible to acquire by character recognition the text data from a telop text included in video data of the content data, and to acquire text data representing characteristics of the program from the information included in the electronic program guide.

[S93] The preference metadata generation unit 223 generates by word extraction the preference metadata from the text data acquired at S92. The preference metadata refers to the data representing a word extracted from textual information relating to the content item selected by the user.

[S94] The preference metadata generation unit 223 stores in the preference metadata storage unit 260 (described above in FIG. 14) the preference metadata generated at S93. Thereafter, the processing returns.

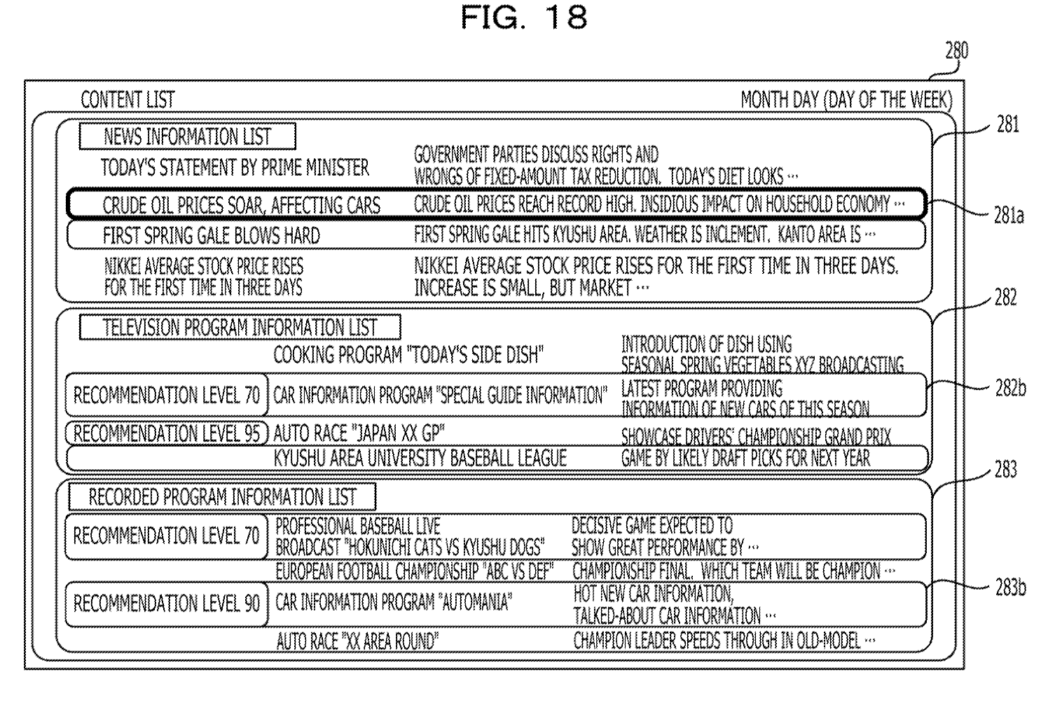

FIG. 18 is a diagram illustrating a content selection screen of the third embodiment. A content selection screen 280 illustrated in FIG. 18 is a screen displayed on the monitor 11 (described above in FIG. 14) of the information processing device 200 (described above in FIG. 14). The content selection screen 280 is an example of a content selection screen which displays a list of content items extracted by the retrieval based on the preference metadata, and which receives an input of selection of a content item.

The content selection screen 280 includes content display areas 281, 282, and 283. Further, the content display area 281 includes a selected content display area 281a representing the content item selected by the user. The content display areas 282 and 283 respectively include relevant content highlight areas 282b and 283b, each of which highlights a content item relevant to the content item selected by the user.

Each of the content display areas 281, 282, and 283 is an area for displaying, by type of content, a list of content items available to the user in the content providing function of the information processing device 200, and which have been extracted as a result of the retrieval based on the preference metadata. The content display area 281 is an area for displaying a list of news content items. The content display area 282 is an area for displaying a list of television program content items. The content display area 283 is an area for displaying a list of recorded program content items.

The user may change the content item to be selected, by shifting the selected content display area 281a with the operation of, for example, the mouse 13 (described above in FIG. 2) connected to the information processing device 200. Further, with an operation such as the clicking of the mouse 13 performed in the selected state of a content item, the user may display a not-illustrated content detail screen to display information representing the details of the content item. Furthermore, with further operation such as the clicking of the mouse 13, the user may display (reproduce) the selected content item to view and/or listen to the content item.

In addition to the presentation of the content item relevant to the metadata, it is also possible to recommend the user a content item from a broader point of view by performing “recommendation display” of, for example, a content item viewed and/or listened to by a large number of users or a content item recommended by the provider thereof.

As described above, the third embodiment generates the preference metadata on the basis of the selection of a content item by the user, and displays on the content selection screen 280 a list of content items available on the basis of the preference metadata of the user. Further, if the user selects a content item interesting to him from the display of the list, other types of content items relevant to the selected content item may be highlighted on the basis of the metadata of the selected content item. Accordingly, it is possible to precisely present and recommend, from different types of content items, content items interesting to the user.

The above-described processing can be realized by a computer. In this case, a program is provided which describes the processing contents of the function that should be held by the information processing device 100 or 200. With the program being executed by the computer, the above-described processing is implemented by the computer.

The program describing the processing contents is recorded in a computer-readable recording medium. The computer-readable recording medium includes a magnetic recording device, an optical disk, a magneto-optical recording medium, a semiconductor memory, and so forth. The magnetic recording device includes an HDD, an FD (Flexible Disk), an MT (Magnetic Tape), and so forth. The optical disk includes a DVD (Digital Versatile Disc), a DVD-RAM, a CD-ROM (Compact Disc-Read Only Memory), a CD-R (Recordable)/RW (ReWritable), and so forth. The magneto-optical recording medium includes an MO (Magneto-Optical disk) and so forth.

In the distribution of the above-described program, a portable recording medium, such as a DVD and a CD-ROM, recorded with the program is sold, for example. Further, it is also possible to store the program in a server computer and transfer the program from the server computer to another computer via a network.

The computer which executes the above-described program stores, in a storage device thereof, the program recorded in a portable recording medium or transferred from the server computer, for example. Then, the computer reads the program from the storage device thereof, and performs the processing according to the program. The computer is also capable of directly reading the program from a portable recording medium and performing the processing according to the program.

The description has been made above of the disclosed content providing device, content providing program, and content providing method, on the basis of the illustrated embodiments. However, the configuration of each of the components can be replaced by an arbitrary configuration having a similar function. Further, the disclosed technique may be added with another arbitrary configuration or process. Further, the disclosed technique may be the combination of two or more arbitrary ones of the above-described embodiments.

The above description is simply for explaining the principle of the present invention. Further, a multitude of alternations and modifications could be made by a person skilled in the art. The disclosed technique is not limited to the precise configurations presented and described above and application examples thereof. Therefore, all corresponding modified examples and equivalents are contemplated as within the scope of the present invention as set forth in the appended claims and equivalents thereof.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A content providing device comprising:
a data storage unit configured to store characteristic data representing characteristics of content items;
a receiving unit configured to receive an input selecting a first content item from the content items;
a retrieval unit configured to retrieve, based on the characteristic data associated with the selected first content item, a second content item different in type from the selected first content item; and
a display information output unit configured to output display information displaying the second content item retrieved by the retrieval unit.

2. The content providing device according to claim 1, further comprising:
a data generation unit configured to acquire additional information relating to the content items, and generate from the acquired additional information the characteristic data stored in the data storage unit.

3. The content providing device according to claim 2,
wherein the data generation unit acquires actual data of the content items, and generates, on the basis of the acquired actual data, the characteristic data.

4. The content providing device according to claim 1, further comprising:
a preference data storage unit configured to store preference data representing a preference of a user; and
a preference retrieval unit configured to retrieve, on the basis of the preference data, a third content item from the content items.

5. The content providing device according to claim 4, further comprising:
a content information storage unit configured to store additional information relating to the content items; and
a preference data generation unit configured to generate from the additional information the preference data stored in the preference data storage unit.

6. The content providing device according to claim 5,
wherein the preference data generation unit acquires actual data of the content items stored in the content information storage unit, and generates, on the basis of the acquired actual data, the preference data.

7. The content providing device according to claim 1,
wherein the display information output unit displays a list of the content items in which content items retrieved by the retrieval unit are highlighted.

8. The content providing device according to claim 2,
wherein the display information output unit outputs additional display information displaying the additional information of the content items.

9. The content providing device according to claim 1, further comprising:
a content information storage unit configured to store the content items;
a content acquisition unit configured to acquire actual data of the content items stored in the content information storage unit; and
a content providing unit configured to provide the content items.

10. A computer-readable recording medium recorded with a content providing program, which when executed by a computer, causes the computer to perform a method comprising:
storing characteristic data representing characteristics of content items;
receiving an input selecting a first content item from the content items;
retrieving, on the basis of the characteristic data associated with the selected first content item, a second content item different in type from the selected first content item; and
outputting display information displaying the retrieved second content item.

11. A content providing method comprising:
storing, in a memory, characteristic data representing characteristics of content items;
receiving an input selecting a first content item from the content items;
retrieving, on the basis of the characteristic data associated with the selected first content item, a second content item different in type from the selected first content item; and
displaying the retrieved second content item.

12. The content providing device according to claim 1, wherein the characteristic data is metadata.

13. The content providing device according to claim 1, wherein the content item is at least one of a video, image, and audio file.
